(19) United States
(12) Patent Application Publication
(10) Pub. No.: US 2004/0150713 A1
(43) Pub. Date: Aug. 5, 2004

(54) Cordless IP video phone

(76) Inventor: Y. P. Cheng, Hong Kong (HK)

Correspondence Address: Michael J. Mauriel, Morrison & Foerster LLP, 425 Market Street, San Francisco, CA, 94105-2482, US

(21) Appl. No.: 10/449,157

(22) Filed: May 29, 2003

Related U.S. Application Data
(60) Provisional application No. 60/444,119, filed on Jan. 31, 2003.

(51) Int. Cl. H04N 7/14

(52) U.S. Cl. 348/14.02; 348/14.04

(57) ABSTRACT

An embodiment of the present invention includes a cordless Internet Protocol (“IP”) phone system. Another embodiment of the present invention provides a cordless video phone system including a base station that may be coupled for communication of audio and video information through a network, such as an IP communication network, and a handset cordlessly coupled for exchanging information with the base station. In one embodiment, the handset includes a camera for capturing video images and the handset is also cordlessly coupled to the base station for sending video information to the base station. In another embodiment, the base station is connectable to a second camera. In other embodiments, the base station is coupled to multiple network interfaces. In other embodiments, the base station and is connectable to a variety of video displays. In one embodiment, the handset and base station communicate through analog signaling and the base station includes digital-to-analog conversion circuitry and analog-to-digital conversion circuitry. In another embodiment, the handset and base station communicate through digital signaling.

### CROSS-REFERENCE TO RELATED APPLICATIONS

The present application claims the benefit of U.S. Provisional Application Serial No. 60/444,119, filed on Jan. 31, 2003, and entitled Cordless IP Video Phone.

### BACKGOUND OF THE INVENTION

Video phones are known in the art. However, video phones in the past have not been widely used. With the proliferation of the Internet and various high bandwidth technologies, use of video phones is becoming more practically feasible. Many past video phones have required the user to interact with equipment that is connected by wire to a data outlet. Other past video phones have provided handheld devices for interacting with a remote wireless network. However, both types of phones have disadvantages. The former type does not allow a user the flexibility of movement that may be desired during a phone call. The latter type typically requires the user to interact with a remote wireless network that may be unreliable or may be undesirable due to high access costs. Also, the latter type does not allow the user the flexibility to select the more advantageous options typically available with hardwire-connected communication systems (e.g., use of a regular telephone network or use of larger display, camera, or other equipment that may be adapted only for hardwire connection).

Cordless phones are known in the context of interaction with a Public Switched Telephone Network (“PSTN”) and typically include a base station having a hardwire connection to a PSTN and a handset using radio frequency (“RF”) signals to interact with the base station. This offers the advantage of connection to the regular PSTN network without having to go through a remote wireless network while still allowing the user flexibility of movement in the vicinity of the base station. However, the advantages of cordless phones have not been adequately realized in the context of video phones and IP phones.

### SUMMARY OF THE INVENTION

In the context of video phones and IP phones, a cordless system can provide advantages beyond those realized by past cordless phones. For example, as will be shown in the context of embodiments of the present invention, a robust base station may be provided in the context of a cordless system that allows connection to multiple communication networks and multiple means of media display and capture.

An embodiment of the present invention provides a cordless video phone system including a base station that may be coupled for communication of audio and video information through a network and a handset that may be cordlessly coupled to the base station for exchanging audio information. In another embodiment, the network is an Internet Protocol (“IP”) communication network. In another embodiment, the handset includes a camera for capturing video images and the handset is also cordlessly coupled to the base station for sending video information to the base station. In another embodiment, the handset is also cordlessly coupled to the base station for sending control information to the base station and for receiving text and other information from the base station. In another embodiment, the handset is also cordlessly coupled to the base station for receiving video information from the base station and displaying video on the handset. In another embodiment, the handset comprises a speaker for hands-free communication when the handset is at a distance from a user. In another embodiment, the base station comprises a speaker for hands-free communication. In another embodiment, the handset comprises an earphone jack for alternative hands-free communication. In another embodiment, the base station may be coupled either to an IP communication network or to a PSTN telephone network for communication between the handset and the IP or PSTN network. In another embodiment, communication between the base station and handset is accomplished through analog RF signaling and the base station includes analog to digital conversion circuits and digital to analog conversion circuits. In another alternative embodiment, cordless communication between the base station and handset is accomplished through digital signaling. In another embodiment, a cordless phone system is provided including a base station that may be coupled for communicating audio information through an Internet Protocol (“IP”) network and a handset that may be cordlessly coupled base station.

### BRIEF DESCRIPTION OF THE DRAWINGS

FIG. 1 illustrates a cordless Internet Protocol (“IP”) video phone system in accordance with an embodiment of the present invention.

FIG. 2 illustrates a base station of the embodiment of FIG. 1 in further detail.

FIGS. 3a and 3b illustrate a handset of the embodiment of FIG. 1 in further detail.

FIG. 4 is a block diagram the exemplary handset elements shown in FIGS. 3a-3b and also showing additional elements.

FIG. 5 is a block diagram of the exemplary base station elements shown in FIG. 2 and also showing additional elements.

### DETAILED DESCRIPTION OF THE EXEMPLARY EMBODIMENTS

The following description is presented to enable any person skilled in the art to make and use the invention, and is provided in the context of particular applications and their requirements. Various modifications to the exemplary embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles and features disclosed herein.

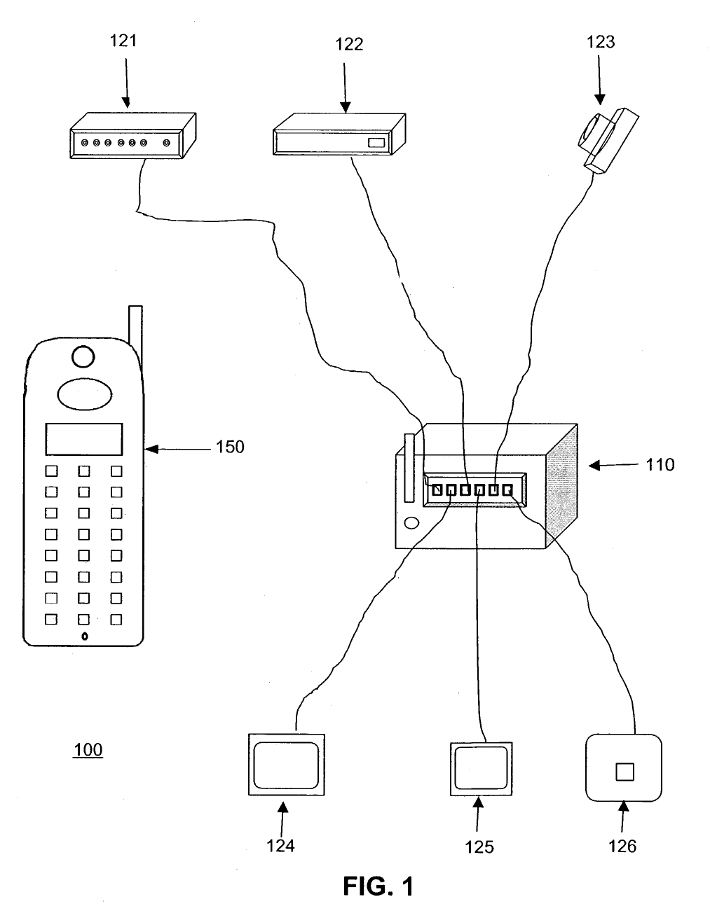

FIG. 1 illustrates a cordless Internet Protocol (“IP”) video phone system 100 in accordance with an embodiment of the present invention and shows peripherals to which system 100 is connectable. System 100 includes a base unit 110 and handset 150.

Base station 110 is shown coupled to ADSL/cable modem 121, V.90/V.92 modem 122, secondary camera 123, television 124, VGA monitor 125, and PSTN telephone line 126.

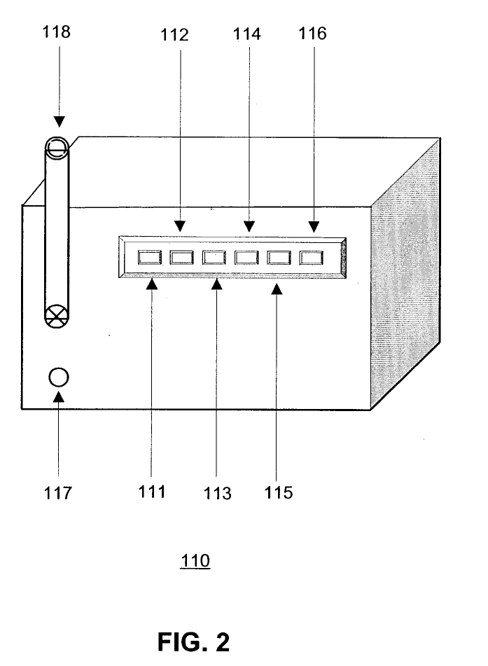

FIG. 2 illustrates base station 110 in further detail. In particular, base station 110 includes broad band Ethernet connector 111, RS232 connector 113, TV connector 112, VGA monitor connector 114, camera connector 115, and PSTN telephone line RJ11 connector 116. These connectors can be used for coupling to peripherals such as, for example, those illustrated in FIG. 1, including, respectively, ADSL/cable modem 121, V.90/V.92 modem 122, television 124, VGA monitor 125, secondary camera 123, and PSTN telephone line 126. Base station 110 also includes DC jack 117 for connecting to an external power supply adapter. Base station 110 also includes antenna 118 for receiving RF video signals from handset 150.

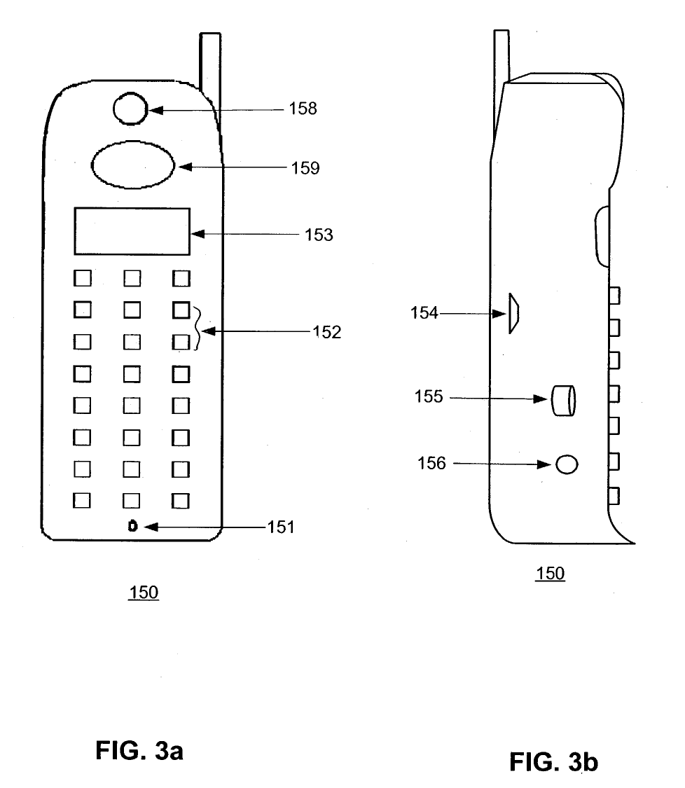

FIGS. 3a and 3b illustrate handset 150 in further detail. Referring to FIG. 3a, handset 150 includes microphone 151, key pad 152, display 153, earpiece 159, and camera 158. Referring to FIG. 3b, handset 150 also includes speaker 154, ringer 155, and earphone jack 156.

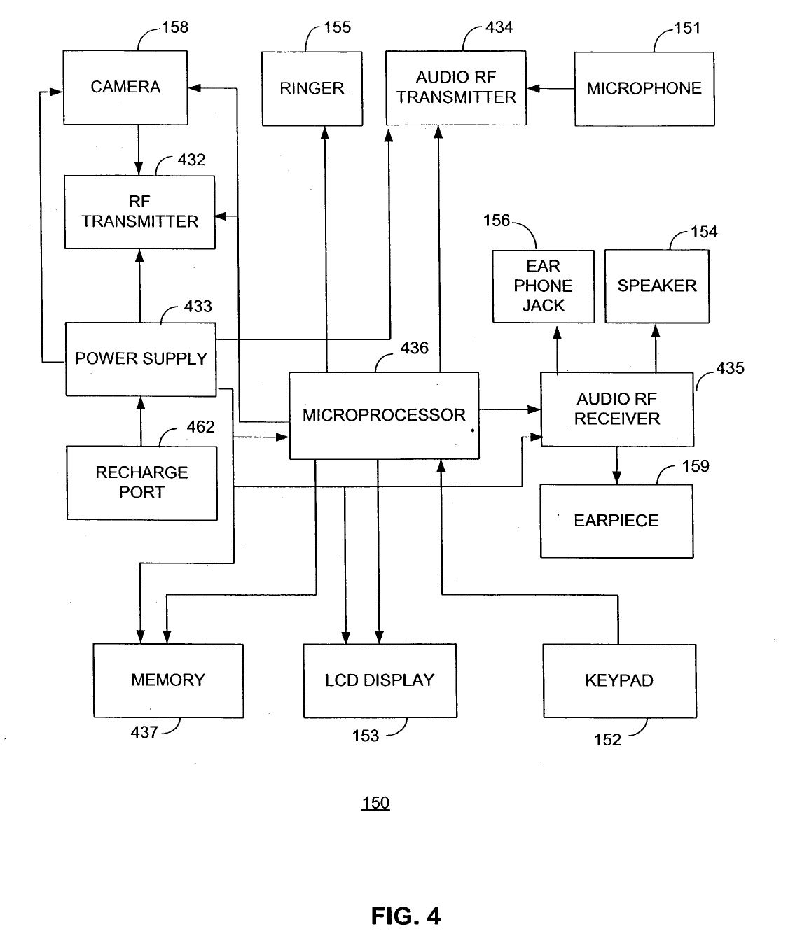

FIG. 4 is a block diagram of handset 150 illustrating the elements shown in FIGS. 3a-3b and also showing additional elements. Cordless handset 150 captures video through camera 158 and then transmits the video signal through RF transmitter 432 to base station 110. Handset 150 captures audio through microphone 151 and transmits the audio signal through RF audio transmitter 434 to base station 110. By pressing keys on the keypad 152 of handset 150, a user may send control signals through transmitter 434 to base station 110 for controlling certain aspects of system 100. For example, input to keypad 152 can be used to control the base unit 110 to connect to either a broad band modem such as, for example, ADSL/Cable modem 121 or a narrower band modem such as, for example, V.90/V.92 modem 122 for sending digital audio and video signals, or to connect to a PSTN telephone line 126 for analog audio communication. Keypad 152 may be used to initiate other control operations as well, such as, for example, volume control or changing software settings. Also, communication may be initiated through use of keypad 152 by, for example, dialing a telephone number or entering an IP address. Commands or dialing data entered through keypad 152 and/or system status data (e.g. which connection is selected, whether a connection has been successfully established, software settings selected, telephone number dialed or to be dialed, IP address accessed or to be accessed, etc.) may be displayed on handset LCD display 153 (controlled by microprocessor 436), or may be displayed on a television (“TV”) such as TV 124 or a monitor such as monitor 125 coupled to base station 110.

Considering FIG. 4 and the operation of handset 150 in further detail, camera 158 is preferably an analog output camera which captures an image and converts it into an analog video signal. The analog video signal is sent to the video RF transmitter 432. Microprocessor 436 selects the frequency channel to be used by RF transmitter 432. Microprocessor 436 is a typical microprocessor such as, for example, an Elan EM78870 microprocessor. The RF transmitter 432 transmits the analog video signal to the base unit 110.

Microphone 151 captures audio (e.g. voice sounds) and converts it into an analog signal that is sent to audio RF transmitter 434. Microprocessor 436 selects the frequency channel to be used by RF transmitter 434. The RF transmitter 434 transmits the analog audio signal to the base unit 110.

Audio RF receiver 435 receives an RF analog audio signal (and may also receive other data signals, e.g., control signals) from the base unit 110. Microprocessor 436 selects the channel used by receiver 435. If “hands free” is activated, then receiver 435, as directed by processor 436, sends the audio signal to the speaker 154 and the earphone jack 156 so that the user may receive audio “hands free” either through speaker 154 or through an external earphone that can be attached to earphone jack 156 (external earphone not separately shown). When an external earphone is attached to earphone jack 156, speaker 154 will be cut off. If “hands free” mode is not activated, then receiver 435 sends the audio signal to earpiece 159.

When a call signal is received through base unit 110 indicating an incoming call, microprocessor 436 will generate a ring sound (e.g. a beep) through ringer 155.

Memory 437 attached to the microprocessor 436 is used for telephone number memory. In alternative embodiments, other types of data may be stored in a memory such as memory 437 as well such as, for example, email addresses, web-page addresses, system settings, text or voice messages or messages/information in other data formats, etc.

A DC power adapter can be attached to the recharge port 462 for charging the power supply 433 on the handset 150 (power adapter not separately shown). Power supply 433 will convert the input voltage from recharge port 462 to different voltages that are needed for camera 158, audio RF transmitter 434, audio RF receiver 435, video RF transmitter 432, LCD display 153, memory 437, and microprocessor 436.

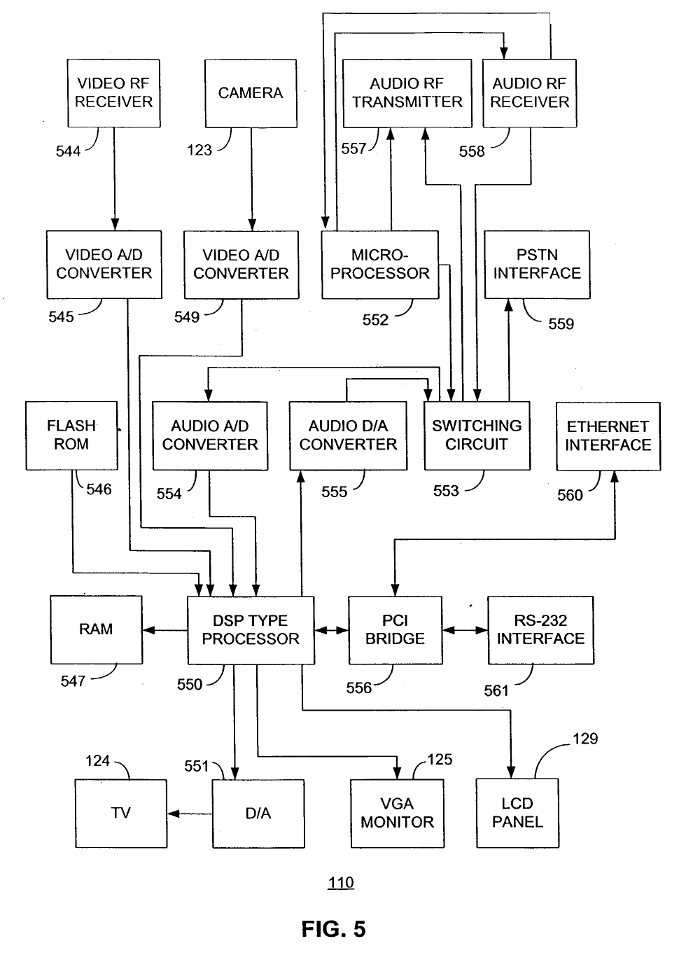

FIG. 5 is a block diagram of base station 110 illustrating the elements shown in FIG. 2 and also showing additional elements. In one example, camera 158 on handset 150 is utilized to capture video images and transmit them to base station 110 as described above (see FIG. 3a and FIG. 4 and accompanying text). Video RF receiver 544 receives the RF video signal from handset 150 video RF transmitter 432 and converts it to an analog video signal. The analog video signal is sent to video analog-to-digital (“A/D”) converter 545. Video A/D converter 545 is a typical analog/digital converter such as, for example, a Philips SAA7113H. Video A/D converter converts the analog video signal to a digital signal. The digital signal is then sent to DSP type processor 550. DSP type processor 550 is a typical DSP processor such as, for example, an Equator Technology Inc. BSP-15. In another example, by contrast, it may be more convenient for a user to utilize a larger camera than camera 158 on handset 150. Thus, a camera such as secondary camera 123 may be connected to base station 110 as shown in FIG. 1. In this example, referring again to FIG. 5, video images are captured by secondary camera 123 and sent as an analog video signal to video A/D converter 549, which is of a similar type to video A/D converter 545.

Audio RF receiver 558 receives the RF signal from the handset 150 audio RF transmitter 434. Audio RF receiver 558 is controlled by microprocessor 552 for channel selection. Microprocessor 552 is a typical microprocessor such as, for example, an Elan EM78910. Audio RF receiver 558 converts the received RF signal into an analog signal. Note that the RF signal received may be either an audio signal or a control signal from handset 150. If the received signal is a control signal, it is sent to processor 552 for initiating control operations. If the received signal is an audio signal, it is sent to switching circuit 553.

In normal telephone mode, microprocessor 552 will control switching circuit 553 to switch the audio signal to PSTN interface 559 so that a regular telephone communication is setup through a PSTN telephone line.

In IP phone or IP video phone mode, microprocessor 552 will control switching circuit 553 to send the audio signal to audio A/D converter 554 to convert the analog audio signal into a digital signal. A/D converter 554 is a typical A/D converter such as a Cirrus Logic CS53L32A.

Both the video digital signal from video A/D converter 545 (or video A/D converter 549) and the audio digital signal from audio A/D converter 554 are sent to the DSP processor 550. DSP processor 550 compresses the audio and video signal and translates those signals into an appropriate protocol which, in the present example, is the ITU H.323 protocol.

DSP processor 550 links with Ethernet interface 560 and RS232 interface 561 through PCI bridge 556. PCI bridge is a typical PCI bridge such as a VIA Technology VT82C686B. Ethernet interface 560 will connect to a broad band modem such as ADSL modem or a Cable modem (e.g. modem 121) for connection to an IP network. The RS232 interface 561 connects to a narrow band modem such as V.90/V.92 modem (e.g. modem 122) for connection to an IP network.

With respect to digital signals received through either Ethernet interface 560 or RS-232 Interface 561, operation proceeds as follows: Signals are linked through PCI bridge 556 to DSP processor 550. Audio signals are processed by DSP processor 550 to decompress and convert the signals from the ITU H.323 protocol. Audio signals are sent to audio digital-to-analog (“D/A”) converter 555. Audio D/A converter 555 is a typical D/A converter such as a Crystal Semiconductor CS4334. Once the signal is converted to analog, it is sent to switching circuit 553 which, under the control of microprocessor 552, switches the signal to audio RF transmitter 557. Audio RF transmitter 557 modulates the audio signal and, under the control of microprocessor 552, transmits the RF signal to the handset audio RF receiver 435.

Other digital signals (non-audio) including those containing video and/or text or other data received through interfaces 560 or 561 are linked through PCI bridge 556 to DSP type processor 550. In the case of display on a TV such as TV 124 (see FIG. 1), DSP 550 sends the video or other non-audio signal to video D/A converter 551. D/A converter 551 is a typical converter such as a Philips SAA 7121. D/A converter 551 converts the digital signal to an analog video signal (which may also include text or other data stream) which is sent to a TV such as TV 124 for display. Processor 550 has a VGA output port (not separately shown) so that video output may be displayed on a monitor such as VGA monitor 125 through VGA monitor connector 114 (see FIGS. 1-2). Other monitors may alternatively be connected through connector 114 such as, for example, an external LCD monitor (external LCD monitor for connection to base station 110 not separately shown). An LCD panel (typically smaller format than an external LCD monitor) such as LCD panel 129 may also be provided as part of base station 110. Processor 550 has an LCD panel output port (not separately shown) for connecting to an LCD panel such as LCD panel 129 as shown.

In one alternative embodiment, video signals may be sent through cordless transmission from a base station to a handset and video may be provided on a display at the handset (e.g., on an LCD display or other display). In such an alternative embodiment, direct connections from a base station to a TV, VGA monitor or other display such as those shown for base station 110 would not necessarily be present.

Base station 110 also includes Flash ROM 546. Flash ROM 546 stores the operating software for DSP processor 550. In a preferred embodiment, DSP software stored in Flash ROM 546 can be upgraded through an IP connection.

Base station 110 also includes RAM 547. RAM 547 works with DSP processor 550 for operating the DSP software.

Although particular embodiments have been described in detail, various modifications to the embodiments described herein may be made without departing from the spirit and scope of the present invention. To cite just one example, the present system may be altered so that cordless communication between base station 110 and handset 150 is accomplished through digital signaling rather than analog RF signaling. In such an alternative an appropriate wireless protocol or other digital signaling protocol may be utilized. Those skilled in the art will appreciate that a handset and base station in accordance with such an alternative would be modified from the handset and base station illustrated herein in accordance with known digital communication techniques. For example, a handset in such an alternative may include a DSP processor to convert captured audio and video information into a digital format prior to transmission to the base station. A handset may, in such an example, include a digital camera rather than an analog output camera and may also include additional circuitry for converting audio into digital signals. These and other variations will be apparent to those skilled in the art and will be understood to be within the scope of the present invention.

What is claimed is:

1. A cordless video phone system comprising:
a base station coupled to a first interface for exchanging information with a first communication network, the base station also being coupled to a first video display port adapted for coupling to a first video display monitor;
a handset cordlessly coupled to the base station for exchanging information with the base station; and
a first camera coupled to the base station to transmit information captured by the first camera to the base station.

2. The cordless video phone system of claim 1, wherein the first communication network is an Internet Protocol (“IP”) communication network.

3. The cordless video phone system of claim 1, wherein the handset comprises the first camera such that coupling between the first camera and the base station is cordless.

4. The cordless video phone system of claim 3, wherein the base station is adapted for coupling to a second camera, the base station being coupled to the first interface for transmitting information captured by either the first or second camera to the first communication network.

5. The cordless video phone system of claim 2, wherein the base station is also coupled to a second interface for exchanging information with a second communication network.

6. The cordless video phone system of claim 2, wherein the base station is also coupled to a second interface for exchanging information with the IP communication network.

7. The cordless video phone system of claim 5, wherein the base station further comprises switching circuitry for selecting either the first or second interface for exchanging information.

8. The cordless video phone system of claim 5, wherein the second interface is a public switched telephone network (“PSTN”) interface and the second communication network is a public switched telephone network.

9. The cordless video phone system of claim 1, wherein the first communication network is a digital communication network and the handset and base station are cordlessly coupled for exchanging analog signals.

10 The cordless video phone system of claim 1, wherein the first communication network is a digital communication network and the handset and base station are cordlessly coupled for exchanging digital signals.

11. The cordless video phone system of claim 1, wherein the first video display port is adapted for coupling to a digital monitor.

12. The cordless video phone system of claim 1, wherein the first video display port is adapted for coupling to a television monitor.

13. The cordless video phone system of claim 12, wherein the first communication network is a digital communication network, the base station further comprising a digital-to-analog converter for converting digital signals received from the first communication network to analog signals for transmission through the first video display port.

14. The cordless video system of claim 12, the base station further comprising:
a second video display port adapted for coupling to a digital monitor.

15. A cordless Internet Protocol (“IP”) phone system comprising:
a base station; and
a handset cordlessly coupled to the base station for exchanging information with the base station;
wherein the base station is coupled to a first interface for exchanging information with an Internet Protocol (“IP”) communication network.

16. The cordless IP phone system of claim 15, wherein the base station is also coupled to a second interface for exchanging information with a second communication network.

17. The cordless IP phone system of claim 16, wherein the second interface is a public switched telephone network (“PSTN”) interface and the second communication network is a public switched telephone network.

18. The cordless IP phone system of claim 16, wherein the base station further comprises switching circuitry for selecting either the first or second interface through which to exchange information.

19. A cordless video phone system comprising:
base station means including first means for exchanging information with a first communication network and means for coupling to a first video display means;
handset means including means for cordlessly exchanging information with the base station means; and
first camera means for capturing information, the first camera means being coupled to the base station for transmitting the captured information to the base station.

20. The cordless video phone system of claim 19, wherein the first communication network is an Internet Protocol (“IP”) communication network.

21. The cordless video phone system of claim 19, wherein the handset means comprises the first camera means such that the means for coupling between the first camera means and the base station means is cordless.

22. The cordless video phone system of claim 21, wherein the base station means further comprises means for coupling to a second camera means.

23. The cordless video phone system of claim 19, wherein the base station means also includes means for exchanging information with a second communication network.

24. The cordless video phone system of claim 20, wherein the base station means also second means for exchanging information with the IP communication network.

25. A method of cordless video phone communication comprising:
coupling a base station to a first interface for exchanging information with an Internet Protocol (“IP”) communication network;
coupling the base station to a first video display port adapted for coupling to a first video display monitor;
cordlessly coupling a handset to the base station for exchanging information with the base station; and
coupling a first camera coupled to the base station to transmit information captured by the first camera to the base station.

26. The method of claim 25, wherein coupling the first camera to the base station comprises cordlessly coupling the camera to the base station through the handset.

27. The cordless video phone system of claim 25, further comprising adapting the base station for coupling to a second camera, wherein coupling of the base station the first interface is for transmitting information captured by either the first or second camera to the first communication network.

28. The method of claim 25, further comprising coupling the base station to a second interface for exchanging information with a second communication network.

29. The method of claim 25, further comprising coupling the base station to a second interface for alternative exchanging of information with the IP communication network.

30. The method of claim 28, wherein the second interface is a public switched telephone network (“PSTN”) interface and the second communication network is a public switched telephone network.
